(19) United States
(12) Patent Application Publication
(10) Pub. No.: US 2025/0314226 A1
(43) Pub. Date: Oct. 9, 2025

(54) FUEL PUMP ASSEMBLY FOR FUEL INJECTED MOTORCYCLES

(71) Applicant: Hobomoped LLC, North Las Vegas, NV (US)

(72) Inventors: Michael S. Spurgin, Las Vegas, NV (US); Dusty Schaller, Las Vegas, NV (US); Ryan Bunderson, Las Vegas, NV (US)

(21) Appl. No.: 19/173,727

(22) Filed: Apr. 8, 2025

Related U.S. Application Data
(60) Provisional application No. 63/575,889, filed on Apr. 8, 2024.

(51) Int. Cl. F02M 59/44; B62J 35/00; F02M 59/48

(52) U.S. Cl. CPC F02M 59/44; B62J 35/00; F02M 59/48

(57) ABSTRACT

Disclosed is a fuel pump assembly, or an upgrade kit for a fuel pump that includes a fuel pump adapter configured to fluidly couple at least one hose to the fuel pump. Also included is at least one fuel pickup device having a first locating magnet disposed on an exterior surface, where the at least one fuel pickup device is fluidly coupled with the fuel pump adapter via the at least one hose. In certain examples, a second locating magnet is also included, and disposed on an external surface of a fuel tank configured to maintain a location of the fuel pickup device with respect to the fuel tank.

### CROSS-REFERENCE TO RELATED APPLICATIONS

This application claims priority to U.S. Provisional Patent Application No. 63/575,889 entitled “FUEL PUMP ASSEMBLY FOR FUEL INJECTED MOTORCYCLES” and filed on Apr. 8, 2024, for Michael S. Spurgin, et al., which is incorporated herein by reference for all purposes.

### FIELD

The subject matter disclosed herein relates to motorcycle fuel systems and more particularly relates to electronic fuel injection systems of motorcycles.

### BACKGROUND

Motorcycle fuel tanks frequently are dimensioned and shaped around a motorcycle frame, and in particular, fuel tanks for offroad motorcycles have fuel tanks that sit on top of a motorcycle frame and then extend downward on both sides of the motorcycle frame. Fuel injected offroad motorcycles have fuel pumps disposed within the fuel tank; however, problems arise when the fuel pump is positioned high in the tank and the fuel level drops below the position of the fuel pump. In this situation, the fuel pump runs dry even though the fuel tank may have up to ¾ of a gallon or more of fuel remaining.

### BRIEF SUMMARY

An apparatus for improving a fuel pump is disclosed. A fuel pump assembly is also disclosed. A method is also disclosed. In certain examples, the apparatus for improving a fuel pump comprises an upgrade kit for the fuel pump. The upgrade kit includes a fuel pump adapter configured to fluidly couple at least one hose to the fuel pump, and at least one fuel pickup device having a first locating magnet disposed on an exterior surface, where the at least one fuel pickup device is fluidly coupled with the fuel pump adapter via the at least one hose. The upgrade kit may also include a second locating magnet disposed on an external surface of a fuel tank configured to maintain a location of the fuel pickup device with respect to the fuel tank.

In certain examples, the upgrade kit includes a fuel filter fluidly coupled with the at least one hose and disposed between the at least one fuel pickup device and the fuel pump adapter. The fuel pickup device comprises a plurality of fuel inlets, where each of the plurality of fuel inlets is coupled with an internal channel. In certain examples, the fuel pickup device includes a check valve disposed within the internal channel and configured to prevent backflow from and loss of prime to the fuel pump.

In certain examples, the upgrade kit includes a tilt sensor device in electrical communication with the fuel pump and configured to stop the operation of the fuel pump in response to detecting an angle of inclination that exceeds a threshold. The threshold is an angle in the range of between about 40 degrees and 80 degrees, in some examples. In certain examples, the tilt sensor device is further configured to stop the operation of the fuel pump if a value of a timer exceeds a threshold time. The threshold time may be in a range of between about 0.1 seconds and about 1 second.

The fuel pump assembly may include a fuel pump and the upgrade kit. In certain examples, the method includes providing a fuel pump, and providing a fuel pump adapter configured to fluidly couple at least one hose to the fuel pump. The method may also include providing at least one fuel pickup device having a first locating magnet disposed on an exterior surface, where the at least one fuel pickup device is fluidly coupled with the fuel pump adapter via the at least one hose. In certain examples, the method also includes providing a second locating magnet disposed on an external surface of a fuel tank configured to maintain a location of the fuel pickup device with respect to the fuel tank. The method may also include providing a tilt sensor device configured to stop the operation of the fuel pump in response to detecting an angle of inclination that exceeds a threshold.

### BRIEF DESCRIPTION OF THE DRAWINGS

A more particular description of the examples briefly described above will be rendered by reference to specific examples that are illustrated in the appended drawings. Understanding that these drawings depict only some examples and are not therefore to be considered to be limiting of scope, the examples will be described and explained with additional specificity and detail through the use of the accompanying drawings, in which:

FIG. 1 is a side view diagram of a fuel pump assembly, in accordance with examples of the subject disclosure;

FIG. 2 is a schematic cross-sectional block diagram illustrating an example of the fuel pump assembly, in accordance with examples of the subject disclosure;

FIG. 3 is a schematic cross-sectional block diagram illustrating another example of the fuel pump assembly, in accordance with examples of the subject disclosure;

FIG. 4 is a schematic block diagram illustrating one example of the tilt sensor device, according to examples of the subject disclosure;

FIG. 5 is a schematic flowchart diagram illustrating one example of a method for preventing the loss of prime of the fuel pump, in accordance with examples of the subject disclosure;

FIG. 6 is a block diagram illustrating a bottom of the fuel tank, in accordance with examples of the subject disclosure;

FIG. 7 is a side view diagram of the fuel pump assembly, in accordance with examples of the subject disclosure;

FIG. 8 is a perspective view diagram illustrating one example of the fuel pump adapter, in accordance with examples of the subject disclosure;

FIG. 9A is a perspective view diagram illustrating one example of the sinker, in accordance with examples of the subject disclosure;

FIG. 9B is a schematic block diagram illustrating one example of the bottom of the sinker, in accordance with examples of the subject disclosure;

FIG. 10 is a perspective view diagram illustrating one example of the topper, in accordance with examples of the subject disclosure;

FIG. 11 is a schematic flowchart diagram illustrating one example of a method in accordance with examples of the subject disclosure; and

FIG. 12 is a schematic block diagram illustrating another example of a fuel pump assembly, in accordance with examples of the subject disclosure.

### DETAILED DESCRIPTION

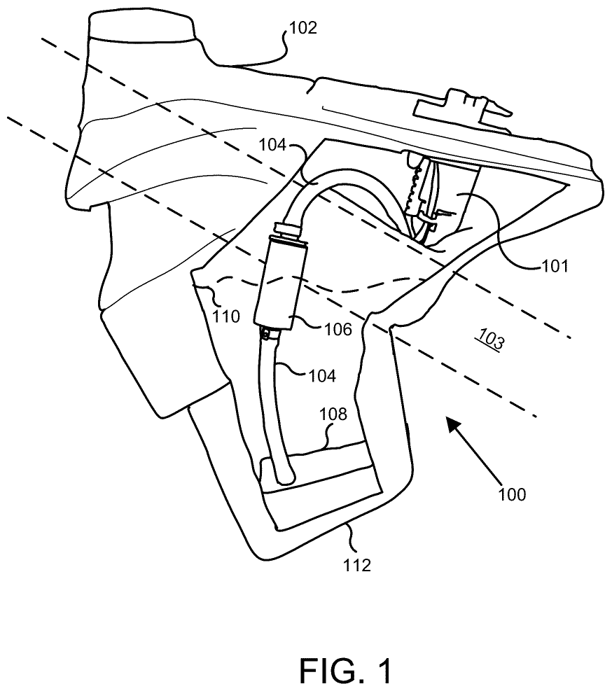

FIG. 1 is a side view diagram of a fuel pump assembly 100, in accordance with examples of the subject disclosure. Depicted is a partial view of a fuel tank 102 disposed on top of a motorcycle frame 103 to allow an internal view of the fuel pump assembly 100. In other words, the depicted fuel tank 102 includes a cutout window to depict the orientation of the fuel pump assembly 100 within the fuel tank 102. Although a specific tank 102 is depicted, it is contemplated that the fuel tank assembly 100 may be adapted for any suitable fuel tank 102. The fuel pump assembly 100, in certain examples, includes a fuel pump 101, hoses 104, a fuel filter 106, and a fuel pickup device (not shown) disposed within slosh foam 108.

The fuel pump assembly 100 of the current disclosure is an upgrade or replacement kit to attach to fuel pumps 101 with pickups that are positioned above a majority of the fuel within the tank. In other examples, the fuel pump assembly 100 is provided with a replacement fuel pump 101 instead of utilizing the OEM fuel pump. For example, in many current generation off-road motorcycles, the fuel pump 101 and its integrated fuel pickup are positioned above the motorcycle frame. Beneficially, the fuel pump assembly 100 includes a pickup device that couples to the fuel pump's integrated fuel pickup and extends down to the bottom of the fuel tank 102, and functions properly even when a fuel level 110 is below the fuel pump 101.

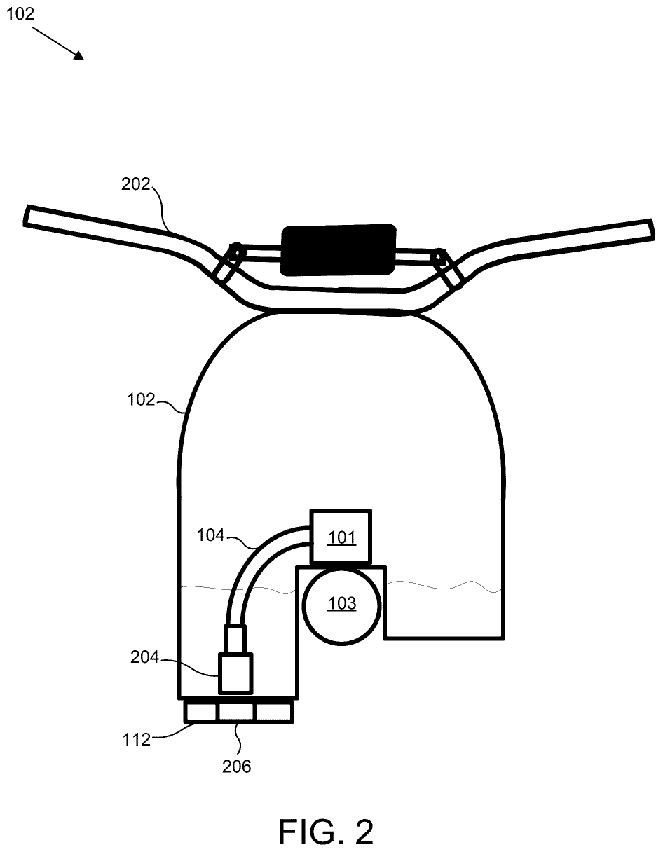

In certain examples, the fuel pump assembly 100 includes the slosh foam 108 disposed around the fuel pickup device (see FIG. 2). Slosh foam 108, in certain examples, is a type of foam used in fuel tanks or fuel cells to prevent fuel from sloshing around in the fuel tank 102 when fuel levels 110 are low. Beneficially, the slosh foam 108 prevents air from being drawn into the fuel pickup device when the fuel level 110 is low. The slosh foam 108 may be formed with a 97% void rate from a polymer material that is fuel resistant.

As will be discussed in greater detail below, the fuel pickup device (not shown here) may be positioned adjacent the bottom of the fuel tank 102 using a magnet positioned on a corresponding exterior surface location of the fuel tank 102. The exterior magnet may be properly positioned using a locating block 112.

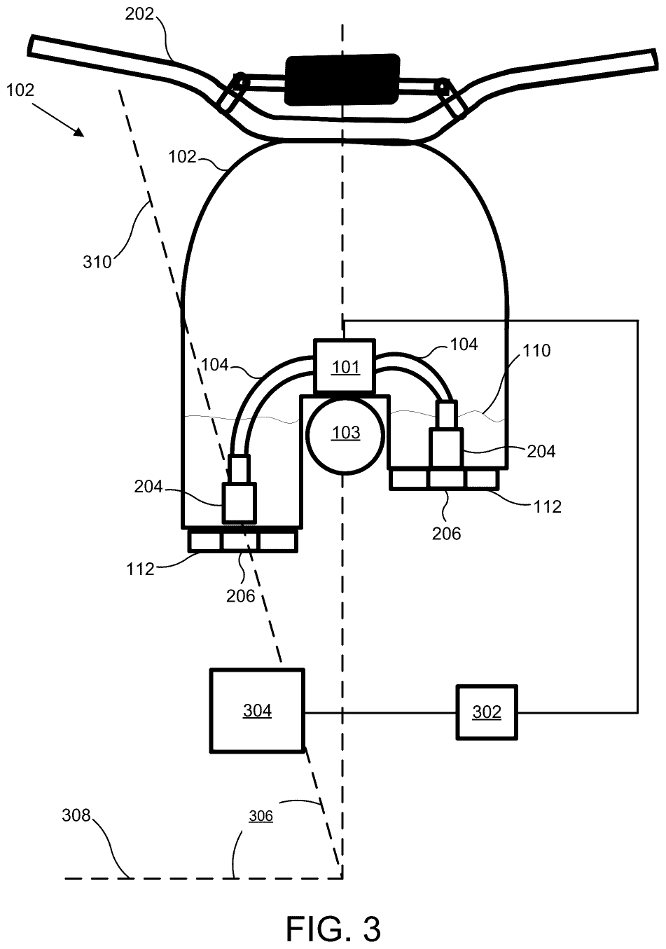

FIG. 2 is a schematic cross-sectional block diagram illustrating an example of the fuel pump assembly 100, in accordance with examples of the subject disclosure. FIG. 2 depicts a view of the fuel tank 102 from the point of view of the rear of the motorcycle looking towards the handlebars 202. Although a single hose 104 and fuel pickup device 204 are depicted, it is contemplated that multiple fuel pickup devices 204 may be used, one for each side of the fuel tank 102, as will be described in greater detail below with reference to FIG. 3.

As described previously, the fuel tank 102 sits on top of the frame 103 of the motorcycle. Portions of the fuel tank 102 may extend downward past the frame 103 on both sides of the frame 103. The downwardly extending portions of the fuel tank 102 need not be symmetric. Stated differently, the fuel tank 102 may extend downward a greater distance on the left side of the frame 103 than on the right side of the frame 103, as depicted, or vice-versa. Current generation off-road motorcycles that position the fuel pump 101 in an area between the side portions of the fuel tank 102 will benefit from the fuel pump assembly 100 of the present disclosure because the fuel pump assembly 100 allows for the use of fuel that is below the fuel pump without relying on splashing of fuel from lower levels onto the pump 101.

In certain examples, the fuel pump 101 is fluidly coupled with the fuel pickup device 204 that is positioned in a lower-most portion of the fuel tank 102. To aid in the proper positioning of the fuel pickup device 204, a magnet 206 may be attached to the outside of the fuel tank 102 in a desired location. The locating block 112 may be provided to correctly position the magnet 206. For example, a locating block 112 may be dimensioned to match a bottom of the fuel tank 102 and have an opening for a magnet 206. In certain examples the locating block 112 and the magnet 206 are attached to the fuel tank 102 using a high-strength adhesive that is compatible with the material of the fuel tank 102.

FIG. 3 is a schematic cross-sectional block diagram illustrating another example of the fuel pump assembly 100, in accordance with examples of the subject disclosure. As described above with reference to FIG. 2, the fuel pump assembly 100 may be configured with two or more hoses 104 and two or more fuel pickup devices 204. It is contemplated that a hose 104 and a fuel pickup device 204 may be utilized for each well that forms the fuel tank 102. In the depicted example, the fuel tank 102 includes two wells, one on each side of the frame 103. Hoses 104 fluidly couple the fuel pickup devices 204 with the fuel pump 101. Slosh foam 108 may be disposed around each fuel pickup device 204.

In certain examples, the fuel pump assembly 100 may include a tilt sensor device 302. The tilt sensor device 302 is in electrical communication with an engine control unit (“ECU”) 304 and the fuel pump 101. The tilt sensor device 302, in certain examples is disposed between the ECU 304 and the fuel pump 101 and is configured to intercept, and in certain situations to be described below, terminate power to the fuel pump 101. In other examples, the tilt sensor device 302 is configured to instruct the fuel pump to shut off.

The tilt sensor device 302 is configured to detect an angle of inclination 306 of the motorcycle. As used herein, “angle of inclination” may refer to an angle 306 between either the positive or negative x-axis 308 and a vertical axis 310 defined by the motorcycle. In other words, the angle of inclination 306 refers to how far over the motorcycle is leaning with respect to a horizontal plane. If the angle of inclination 306 exceeds a threshold value, it is possible that the fuel level 110 is angled in such a way as to at least partially expose the fuel pickup device 204 to air. Beneficially, the tilt sensor device 302 prevents this situation by cutting power to the fuel pump 101 if the angle of inclination 306 exceeds a threshold value for a predetermined length of time. This prevents air from entering the fuel pickup device 204 and the fuel pump 101 subsequently losing prime.

In certain examples, the tilt sensor device 302 is configured to cut power, or otherwise instruct the fuel pump 101 to turn off, when the angle of inclination 306 exceeds a threshold angle value in the range of between about 40 and about 80 degrees. As used herein, the phrase exceed/exceeds/exceeding a threshold angle may refer to a measured value dropping below or rising above the threshold value. For example, when the motorcycle is substantially vertical, the measured angle of inclination 306 is about 90 degrees. When a user rides the motorcycle through a corner and leans over, the angle of inclination 306 may drop to about 70 degrees, for example. In this example, if the threshold angle value is about 75 degrees, the measured angle has “exceeded”, or dropped below, the threshold angle value by about 5 degrees.

In other examples, the tilt sensor device 302 is configured with a threshold angle value in the range of between about 55 degrees and 75 degrees. In yet other examples, the tilt sensor device 302 is configured with a threshold angle value in the range of between about 62 degrees and 72 degrees. In yet other examples, the tilt sensor device 302 is configured with a threshold angle value of about 67 degrees. As used herein, the terms “about” or “substantially”, when referring to a numerical value, includes values that are ±10% of the referenced value. For example, “about 67 degrees” may also include values that are ±10% of 67 degrees.

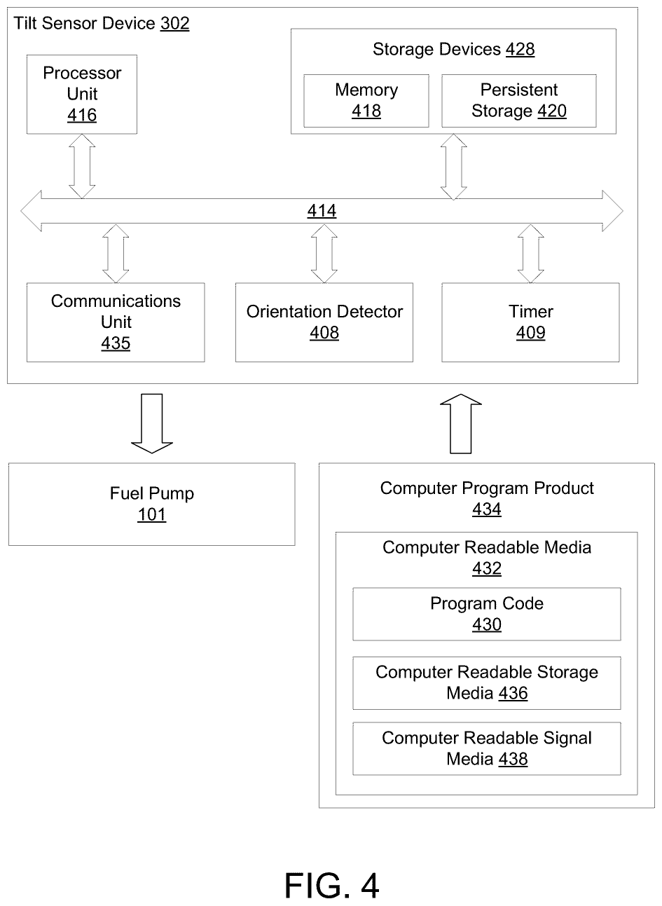

FIG. 4 is a schematic block diagram illustrating one example of the tilt sensor device 302, according to examples of the subject disclosure. The tilt sensor device 302 is an example of a computing device, which, in some examples, is used to implement one or more components of examples of the disclosure, and in which computer usable program code or instructions implementing the processes can be located for the illustrative examples. In this illustrative example, the tilt sensor device 302 includes a communications fabric 414, which provides communications between a processor unit 416, memory 418, orientation detector 408, timer 409, persistent storage 420, a communications unit 435, and a display 437.

In certain examples, the tilt sensor device 302 includes an orientation detector 408 for detecting the angle of inclination of the motorcycle. The orientation detector 408 may comprise an accelerometer, a gyroscope, or a magnetometer. It is contemplated that other suitable devices for detecting an angle of inclination may be utilized also. A timer 409 is configured to track an amount of time that has passed since an event.

The processor unit 416 serves to execute instructions for software that are loaded into memory 418 in some examples. In one example, the processor unit 416 is a set of one or more processors or can be a multi-processor core, depending on the particular implementation. Further, the processor unit 416 is implemented using one or more heterogeneous processor systems, in which a main processor is present with secondary processors on a single chip, according to some examples. As another illustrative example, the processor unit 416 is a symmetric multi-processor system containing multiple processors of the same type.

Memory 418 and persistent storage 420 are examples of storage devices 428. A storage device is any piece of hardware that is capable of storing information, such as, for example, without limitation, data, program code in functional form, and/or other suitable information either on a temporary basis and/or a permanent basis. Memory 418, in these examples, is a random-access memory, or any other suitable volatile or non-volatile storage device. Persistent storage 420 takes various forms, depending on the particular implementation. In one example, persistent storage 420 contains one or more components or devices. In an example, persistent storage 420 is a hard drive, a flash memory, a rewritable optical disk, a rewritable magnetic tape, or some combination of the above. The media used by persistent storage 420 is removable in some examples. For example, a removable hard drive is used for persistent storage 420 in various implementations.

The communications unit 435, in these examples, provides for communication with other data processing systems or devices. In some examples, the communications unit 435 is a network interface card. The communications unit 435 provides communications through the use of either, or both, physical and wireless communications links. In some examples, the communication unit 435 also provides a connection for user input through a keyboard, a mouse, and/or some other suitable input device. In other examples, the communications unit 435 is a wired connection to the fuel pump 101 that either instructs the fuel pump 101 or selectively provides power to the fuel pump 101.

In some examples, instructions for the operating system, applications, and/or programs are located in the storage devices 428, which are in communication with the processor unit 416 through the communications fabric 414. In these illustrative examples, the instructions are in a functional form on persistent storage 420. These instructions are loaded into memory 418 for execution by the processor unit 416 in some examples. In certain examples, the processes of the different examples are performed by the processor unit 416 using computer implemented instructions, which is located in a memory, such as the memory 418.

These instructions are referred to as program code, computer usable program code, or computer readable program code that can be read and executed by a processor in the processor unit 416. The program code, in the different examples, is embodied on different physical or computer readable storage media, such as the memory 418 or the persistent storage 420.

Program code 430 is located in a functional form on computer readable media 432 that is selectively removable and can be loaded onto or transferred to the tilt sensor device 302 for execution by the processor unit 416. The program code 430 and computer readable media 436 form computer program product 434. In one example, the computer readable media 432 is a computer readable storage media 436 or a computer readable signal media 438. The computer readable storage media 436 includes, in one example, an optical or magnetic disc that is inserted or placed into a drive or other device that is part of the persistent storage 420 for transfer onto a storage device, such as a hard drive, that is part of the persistent storage 420. In other examples, the computer readable storage media 436 also takes the form of a persistent storage, such as a hard drive, a thumb drive, or a flash memory that is connected to the tilt sensor device 302. In some instances, the computer readable storage media 436 is not removable from the tilt sensor device 302.

Alternatively, the program code 430 is transferred to the tilt sensor device 302 using computer readable signal media 438. Computer readable signal media 438 is, as one example, a propagated data signal containing program code 430. For example, the computer readable signal media 438 is an electromagnetic signal, an optical signal, and/or any other suitable type of signal in one example. These signals are transmitted over communications links, such as wireless communication links, an optical fiber cable, a coaxial cable, a wire, and/or any other suitable type of communications link. In other words, the communications link and/or the connection is physical or wireless in the illustrative examples. The computer readable media also takes the form of non-tangible media, such as communications links or wireless transmissions containing the program code, in some examples.

In some illustrative examples, the program code 430 is downloaded over a network to the persistent storage 420 from another device or data processing system through the computer readable signal media 438 for use within the tilt sensor device 302. In one instance, program code stored in a computer readable storage media in a server data processing system is downloaded over a network from a server to the tilt sensor device 302. According to various examples, the system providing the program code 430 is a server computer, a client computer, or some other device capable of storing and transmitting program code 430. In other instances, the program code is written directly to the storage device 428 by a firmware update tool.

The different components illustrated for the tilt sensor device 302 are not meant to provide physical or architectural limitations to the manner in which different examples can be implemented. The different illustrative examples can be implemented in a controller including components in addition to and/or in place of those illustrated for the tilt sensor device 302. Other components shown in FIG. 4 can be varied from the illustrative examples shown. The different examples can be implemented using any hardware device or system capable of executing program code. For example, a storage device in the tilt sensor device 302 is any hardware apparatus that can store data. The memory 418, persistent storage 420, and the computer readable media 432 are examples of storage devices in a tangible form.

In another example, a bus system is used to implement communications fabric 414 and can be comprised of one or more buses, such as a system bus or an input/output bus. Of course, in some examples, the bus system is implemented using any suitable type of architecture that provides for a transfer of data between different components or devices attached to the bus system. In addition examples, a communications unit includes one or more devices used to transmit and receive data, such as a modem or a network adapter. Further, a memory is, for example, the memory 418 or a cache such as found in an interface and memory controller hub that can be present in the communications fabric 414.

Computer program code for carrying out operations for aspects of the subject disclosure can be written in any combination of one or more programming languages, including an object-oriented programming language such as Java, Python, C++ or the like and conventional procedural programming languages, such as the “C” programming language or similar programming languages. The program code can execute as a stand-alone software package.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks

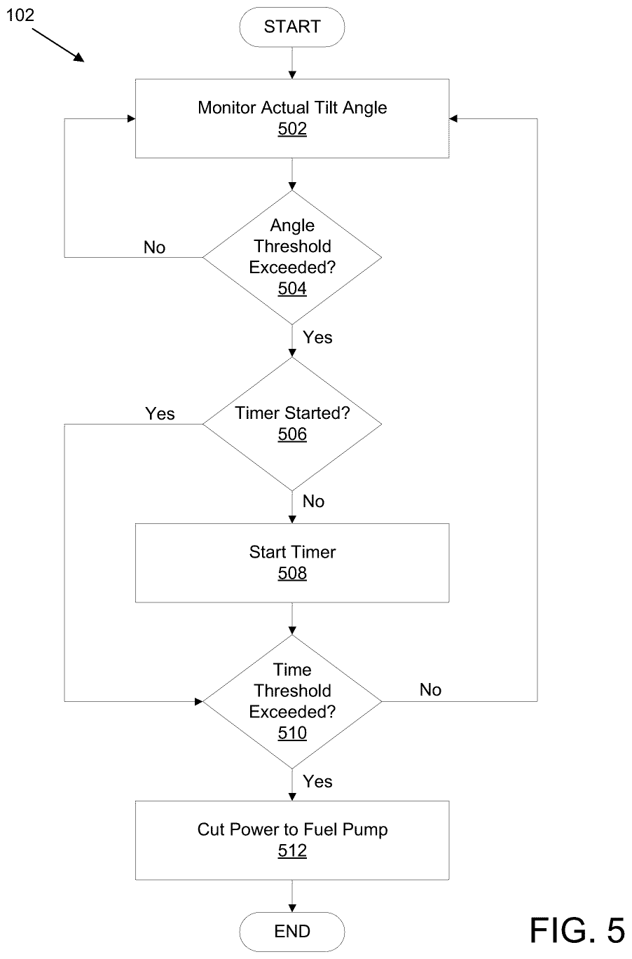

FIG. 5 is a schematic flowchart diagram illustrating one example of a method 500 for preventing the loss of prime of the fuel pump 101, in accordance with examples of the subject disclosure. In certain examples, the tilt sensor device 302 executes the steps depicted in FIG. 5. The method 500 begins, and the tilt sensor device 302 monitors, at block 502, the actual tilt angle of the motorcycle. In certain examples, the tilt sensor device 302 samples the actual tilt angle between 10 and 100 times per second. However, other sampling frequencies are contemplated, and any suitable sampling frequency may be used.

While monitoring the actual tilt angle, the tilt sensor device 302 compares the measured angle with a threshold and determines, at block 504, whether the measured angle exceeds a predetermined threshold angle. If the determination is “no” the method continues at block 502 after resetting a timer to zero. If the measured angle exceeds the threshold angle, the tilt sensor device 302 determines, at block 506, if a timer has already been started. If not, a timer is started. The tilt sensor device 302 then determines, at block 510, if the value of the timer exceeds a threshold time. If the value of the timer exceeds a threshold time value, then the tilt sensor device 302 cuts power to the fuel pump, at block 512. If the value of the timer, at block 510, does not exceed a time threshold value, then the method continues at block 502. In certain examples, the time threshold is in the range of between about 0.1 seconds and 1 second. In other examples, the time threshold is in the range of between about 0.4 seconds and 0.6 seconds. The threshold time may be adapted to the style of riding of the user. For example, a user that rides his/her motorcycle on a racetrack may desire a longer time threshold to allow for riding through long corners.

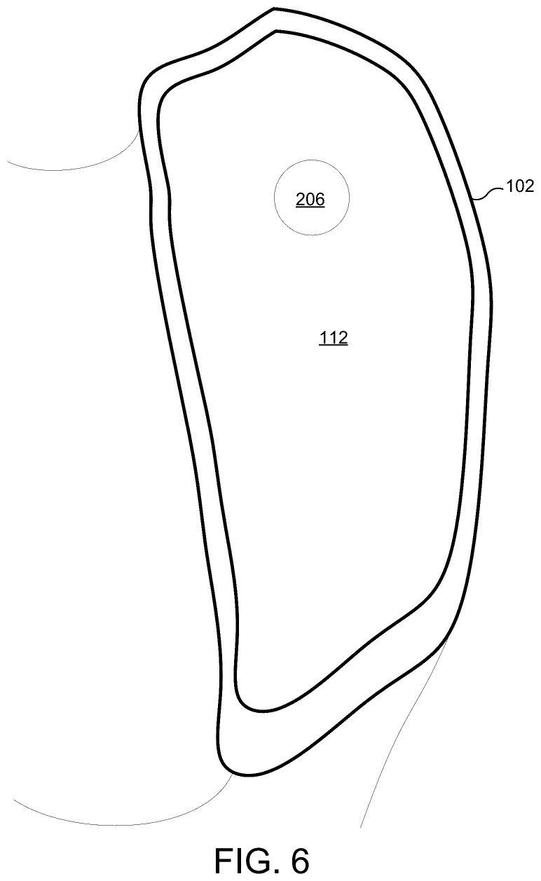

FIG. 6 is a block diagram illustrating a bottom of the fuel tank 102, in accordance with examples of the subject disclosure. The locating block 112 may be shaped in any desired shape. In certain examples, the locating block 112 is shaped similarly to the bottom of the fuel tank 102 to aid a user in correctly positioning the magnet 206 with respect to the bottom of the fuel tank 102. In other examples, the locating block 112 may be any desired shape. In yet other examples, the magnet 206 is positioned without a locating block 112. In yet other examples, the locating block 112 and/or magnet 206 are positioned on sides of the fuel tank 102.

The magnet 206 may be adhered to the fuel tank 102 using any suitable adhesive or fastening mechanism. Although a circular magnet 206 is depicted, other geometric shapes are contemplated. The magnet 206, in certain examples, is a high-strength neodymium magnet. Together with a magnet disposed in the bottom of the fuel pickup device 204, the magnet 206 maintains the position of the fuel pickup device 204 in the bottom of the fuel tank 102 even with all of the movement that is typically involved when riding motorcycles in offroad environments.

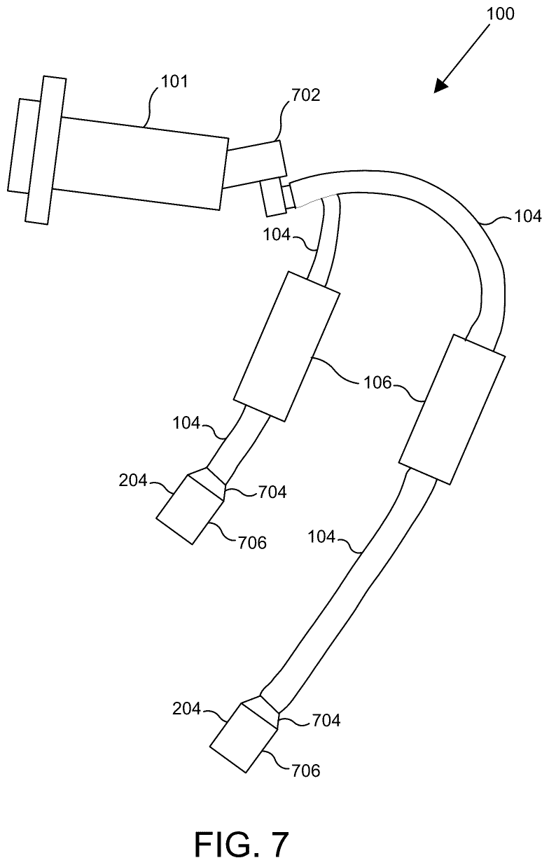

FIG. 7 is a side view diagram of the fuel pump assembly 100, in accordance with examples of the subject disclosure. The fuel pump assembly 100, as described above, includes the fuel pump 101, one or more hoses 104, one or more fuel filters 106, and one or more fuel pickup devices 204. In certain examples, the fuel pump assembly 100 includes a fuel pump adapter 702 that is configured to attach to a fuel inlet of the fuel pump 101 and allow the hose 104 to connect to the fuel pump 101. The fuel pump adapter 702 may be coupled to the fuel pump using any suitable fastener. In certain examples, the fuel pump adapter 702 is shaped and dimensioned to correspond with the inlet of the fuel pump 101.

The fuel pickup device 204, in certain examples, is formed of multiple components including a topper 704 and a sinker 706. Alternatively, the fuel pickup device 204 is a single unitary component. In certain examples, the fuel pickup device 204 includes an internal check valve to maintain the fuel pump 101 in a primed state. The internal check valve, in certain examples, is a ball that is movable within a chamber inside of the sinker 706 to prevent backflow.

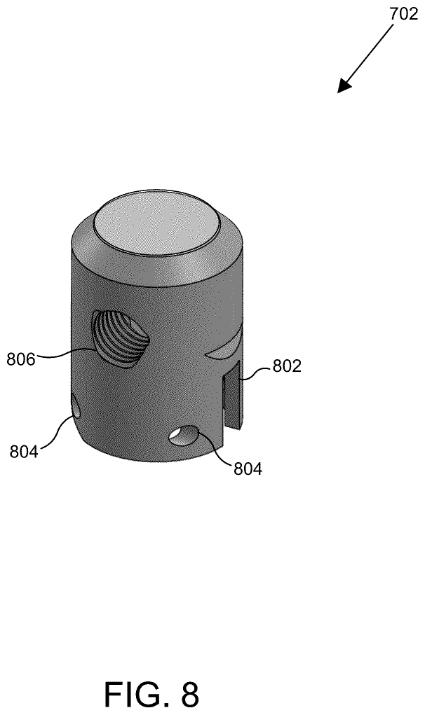

FIG. 8 is a perspective view diagram illustrating one example of the fuel pump adapter 702, in accordance with examples of the subject disclosure. The fuel pump adapter 702 is formed of, in certain examples, a material that is resistant to the corrosive effects of fuel. Examples of a suitable material include, but are not limited to, certain polymer materials, and certain lightweight metal alloys.

The depicted fuel pump adapter 702 includes notches 802 and other features that are adapted to a specific fuel pump 101. For example, the depicted fuel pump adapter 702 is adapted to couple to a fuel pump 101 that is included in KTM™, Husqvarna™, or GasGas™ offroad motorcycles. Openings 804 are provided to allow fasteners (e.g., pins, rivets, screws, etc.) to couple the fuel pump adapter 702 to the fuel pump 101. Opening 806 is fluidly coupled with a fuel pump 101 engaging surface and is provided to fluidly couple the fuel hose 104 with the fuel pump 101.

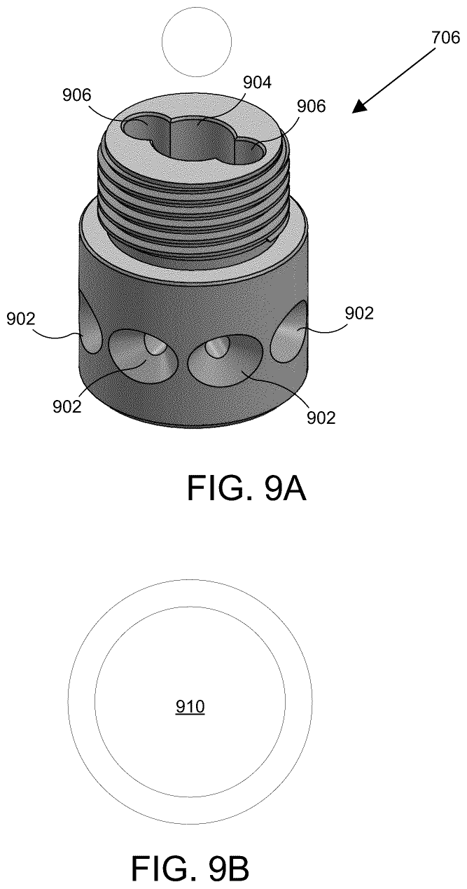

FIG. 9A is a perspective view diagram illustrating one example of the sinker 706, in accordance with examples of the subject disclosure. The sinker 706, in certain examples, includes one or more fluid inlets 902 positioned radially around the base of the sinker 706. In certain examples, the sinker 706 includes a fuel inlet 902 positioned every 45 degrees for a total of 8 fuel inlets. In other examples, any suitable number of fluid inlets 902 is acceptable.

Each of the fluid inlets 902 is fluidly coupled with an internal chamber 904 of the sinker 706. The internal chamber may be shaped as depicted having a central portion 904 and left 906 and right chambers 908. In certain examples, a ball check valve is disposed within the central chamber. When the fuel pump is operating, fuel flow causes the ball to float in the internal chamber, which allows fuel to flow around the ball in the left 906 and right chambers 908, otherwise the ball sinks to the bottom and blocks the fuel inlets 902.

FIG. 9B is a schematic block diagram illustrating one example of the bottom of the sinker 706, in accordance with examples of the subject disclosure. In certain examples, a magnet 910 is disposed in the bottom of the sinker 706. The magnet 910 corresponds to the external magnet 206 described above. In other words, the magnet 910 is also a high strength magnet, but oriented to be attracted to the external magnet 206. In other examples, only a single magnet is used to position the sinker 706 properly within the fuel tank 102.

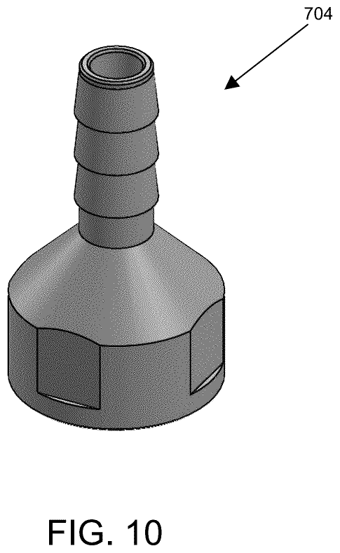

FIG. 10 is a perspective view diagram illustrating one example of the topper 704, in accordance with examples of the subject disclosure. The topper 704 is configured to fluidly couple, in certain examples, the sinker 706 with the fuel hose 104. In certain examples, both the topper 704 and the sinker 706 are formed of a fuel resistant metal material or metal alloy. In other examples, the topper 704 and the sinker 706 are formed of a fuel resistant polymer material.

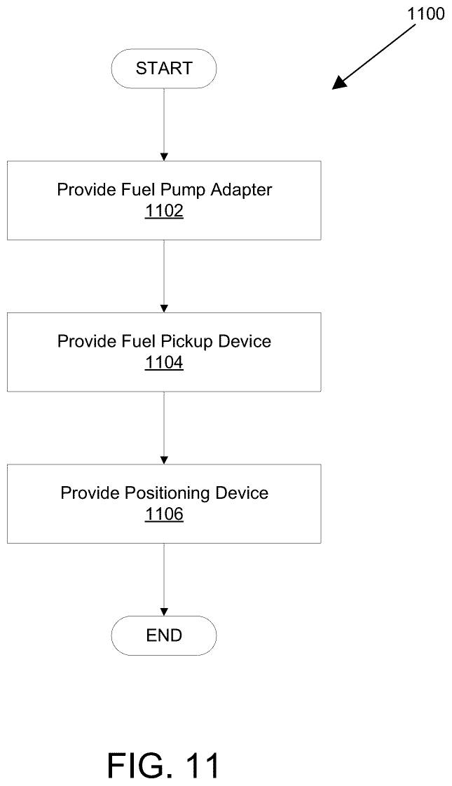

FIG. 11 is a schematic flowchart diagram illustrating one example of a method 1100 in accordance with examples of the subject disclosure. The method 1100 starts and, at block 1102, a fuel pump adapter is provided. In certain examples, the fuel pump adapter is provided and configured as described above with respect to FIGS. 1-10. The method 1100 continues and, at block 1104, the fuel pickup device is provided. In certain examples, the fuel pickup device is provided with a sinker and a topper, as described above. In other examples, the fuel pickup device is a unitary device. At block 1106 the positioning device is provided. In certain examples, the positioning device is the external magnet and the locating block. In other examples, the positioning device is either the internal or the external magnet, or both.

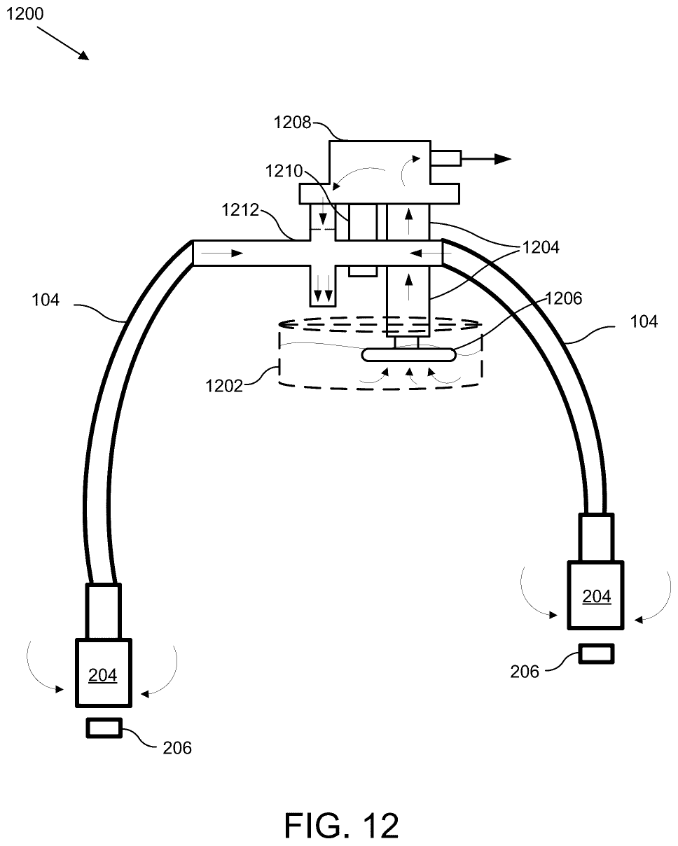

FIG. 12 is a schematic block diagram illustrating another example of a fuel pump assembly 1200, in accordance with examples of the subject disclosure. The depicted example has omitted several components for the sake of clarity, including the fuel tank that straddles the frame of the motorcycle. In certain examples, the fuel tank includes a central “cup” 1202 that is formed by the fuel tank. The cup 1202, or central basin is disposed around a fuel pump 1204. The fuel pump 1204, in certain examples, is a lift pump that is configured to draw fuel through a fuel filter 1206 and lift the fuel to a fuel pump tank fitting 1208.

In certain examples, the fuel pump tank fitting 1208 is configured with an internal chamber that fluidly couples the fuel pump 1204 with a pressure regulator 1210 and a Venturi adapter 1212. The fuel pump 1204 is configured to provide pressure that is greater than the pressure required by the fuel system of the motorcycle so that the additional pressure may drive fuel past the pressure regulator 1210 and into the Venturi adapter 1212. In certain examples, the fuel system of the motorcycle requires 50 psi, and the fuel pump is configured to operate at 100 psi. The pressure regulator 1210 bleeds off half of the fuel pressure into the Venturi adapter 1212 which is passed through a narrow opening in the Venturi adapter 1212. The Venturi adapter 1212 fluidly couples the fuel pickup devices 204 with excess output from the fuel pump 1204. As known to those having skill in the art, fluids passing through narrow openings cause the pressure of the fluid to drop and the velocity to increase. This drop in pressure beneficially draws fuel up the hoses 104 from the fuel pickup devices 204. The excess fuel from the fuel pump 1204 and the fuel pickup devices 204 is dumped into the central basin 1202. This beneficially keeps the central basin full at all times. Another benefit is that a single fuel pump is used instead of a lift pump and a separate jet pump, for example.

Reference throughout this specification to “one example,” “an example,” or similar language means that a particular feature, structure, or characteristic described in connection with the example is included in at least one example. Thus, appearances of the phrases “in one example,” “in an example,” and similar language throughout this specification may, but do not necessarily, all refer to the same example, but mean “one or more but not all examples” unless expressly specified otherwise. The terms “including,” “comprising,” “having,” and variations thereof mean “including but not limited to” unless expressly specified otherwise.

Furthermore, the described features, structures, or characteristics of the disclosure may be combined in any suitable manner in one or more examples. In the following description, numerous specific details are provided to give a thorough understanding of examples of the disclosure. One skilled in the relevant art will recognize, however, that the example may be practiced without one or more of the specific details, or with other methods, components, materials, and so forth. In other instances, well-known structures, materials, or operations are not shown or described in detail to avoid obscuring aspects of the disclosure.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and

C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present disclosure may be embodied in other specific forms without departing from its spirit or essential characteristics. The described examples are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An upgrade kit for a fuel pump, the upgrade kit comprising:
a fuel pump adapter configured to fluidly couple at least one hose to the fuel pump;
at least one fuel pickup device having a first locating magnet disposed on an exterior surface, where the at least one fuel pickup device is fluidly coupled with the fuel pump adapter via the at least one hose; and
a second locating magnet disposed on an external surface of a fuel tank configured to maintain a location of the fuel pickup device with respect to the fuel tank.

2. The upgrade kit of claim 1, further comprising a fuel filter fluidly coupled with the at least one hose and disposed between the at least one fuel pickup device and the fuel pump adapter.

3. The upgrade kit of claim 1, where the at least on fuel pickup device comprises a plurality of fuel inlets, where each of the plurality of fuel inlets is coupled with an internal channel.

4. The upgrade kit of claim 3, further comprising a check valve disposed within the internal channel and configured to prevent backflow from and loss of prime to the fuel pump.

5. The upgrade kit of claim 1, further comprising a tilt sensor device in electrical communication with the fuel pump and configured to stop an operation of the fuel pump in response to detecting an angle of inclination that exceeds a threshold.

6. The upgrade kit of claim 5, where the threshold is an angle in a range of between about 40 degrees and 80 degrees.

7. The upgrade kit of claim 5, where the tilt sensor device is further configured to stop the operation of the fuel pump if a value of a timer exceeds a threshold time.

8. The upgrade kit of claim 7, where the threshold time is in a range of between about 0.1 seconds and about 1 second.

9. A fuel pump assembly comprising:
a fuel pump;
a fuel pump adapter configured to fluidly couple at least one hose to the fuel pump;
at least one fuel pickup device having a first locating magnet disposed on an exterior surface, where the at least one fuel pickup device is fluidly coupled with the fuel pump adapter via the at least one hose; and
a second locating magnet disposed on an external surface of a fuel tank configured to maintain a location of the fuel pickup device with respect to the fuel tank.

10. The fuel pump assembly of claim 9, further comprising a fuel filter fluidly coupled with the at least one hose and disposed between the at least one fuel pickup device and the fuel pump adapter.

11. The fuel pump assembly of claim 9, where the at least on fuel pickup device comprises a plurality of fuel inlets, where each of the plurality of fuel inlets is coupled with an internal channel.

12. The fuel pump assembly of claim 11, further comprising a check valve disposed within the internal channel and configured to prevent backflow from and loss of prime to the fuel pump.

13. The fuel pump assembly of claim 9, further comprising a tilt sensor device in electrical communication with the fuel pump and configured to stop an operation of the fuel pump in response to detecting an angle of inclination that exceeds a threshold.

14. The fuel pump assembly of claim 13, where the threshold is an angle in a range of between about 40 degrees and 80 degrees.

15. The fuel pump assembly of claim 13, where the tilt sensor device is further configured to stop the operation of the fuel pump if a value of a timer exceeds a threshold time.

16. The fuel pump assembly of claim 15, where the threshold time is in a range of between about 0.1 seconds and about 1 second.

17. The fuel pump assembly of claim 9, further comprising at least one slosh foam disposed adjacent the fuel pickup device.

18. The fuel pump assembly of claim 9, further comprising a locating block configured to house and locate the at least second magnet with respect to the fuel tank.

19. A method comprising:
providing a fuel pump;
providing a fuel pump adapter configured to fluidly couple at least one hose to the fuel pump;
providing at least one fuel pickup device having a first locating magnet disposed on an exterior surface, where the at least one fuel pickup device is fluidly coupled with the fuel pump adapter via the at least one hose; and
providing a second locating magnet disposed on an external surface of a fuel tank configured to maintain a location of the fuel pickup device with respect to the fuel tank.

20. The method of claim 19, further comprising, providing a tilt sensor device configured to stop an operation of the fuel pump in response to detecting an angle of inclination that exceeds a threshold.
